(19) United States
(12) Patent Application Publication
(10) Pub. No.: US 2008/0172414 A1
(43) Pub. Date: Jul. 17, 2008

(54) Business Objects as a Service

(75) Inventors: Ian Tien, Seattle, WA (US); Corey Hulen, Sammamish, WA (US); Chen-I Lim, Bellevue, WA (US); Brent Wilson, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/623,818

(22) Filed: Jan. 17, 2007

(51) Int. Cl. G06F 17/30

(52) U.S. Cl. 707/104.1; 707/E17.005

(57) ABSTRACT

Hosted business service applications are provided enabling users to download and run plug-in modules associated with scorecard operations. Plug-in modules are launched from context-based links provided by the service or by third parties providing users the ability to work with the hosted application with a substantially same responsiveness and reliability as a natively installed application, to continue working while disconnected from the core service, and to have services upgraded without significantly disrupting their work. Client shell can be billed by the service or by third parties for the use of the business service by tracking activities associated with the downloaded module.

### BACKGROUND

Key Performance Indicators (KPIs) are quantifiable measurements that reflect the critical success factors of an organization ranging from income that comes from return customers to percentage of customer calls answered in the first minute. Key Performance Indicators may also be used to measure performance in other types of organizations such as schools, social service organizations, and the like. Measures employed as KPI within an organization may include a variety of types such as revenue in currency, growth or decrease of a measure in percentage, actual values of a measurable quantity, and the like.

comprehensive business logic applications for creating and processing scorecards typically have the disadvantage of lacking ease of availability to users. For example, a subscriber may have to install the whole application suite when he or she changes machines. While some hosted solutions for managing business performance information with analytic and reporting capabilities are provided, the hosting typically takes a pure-browser approach, enabling customers to interact with the software without requiring particular subscriber or administrative rights on their machines to install new software. The drawback of such system is that the responsiveness of the applications may be limited and offline interaction may not be possible.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to enabling users to download and run a business logic application such as a scorecard application hosted by a client deployed service platform. Plug-in modules may be launched in a context-based manner from a client shell using links provided by the service or by other providers. Additional functionality and services such as maintenance, offline synchronization, security, billing, and the like may be provided by the service or other providers as well.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates a screenshot of an example scorecard.

FIG. 2 illustrates an example solution architecture for business objects using a client deployment platform;

FIG. 3 illustrates an example application architecture for business objects using a client deployment platform;

FIG. 4 illustrates an example user interface for selecting a scorecard template in a client deployed application;

FIG. 5 illustrates an example user interface for scorecard operations in a client deployed application;

FIG. 6 illustrates an example scorecard and report views in a client deployed scorecard application;

FIG. 7 illustrates implementation of client deployed business performance applications in a networked system;

FIG. 8 is a block diagram of an example computing device operating environment, where embodiments may be implemented; and

FIG. 9 illustrates a logic flow diagram for a process of installing and operating a client deployed scorecard application.

### DETAILED DESCRIPTION

As briefly described above, users may be enabled to download and run a fully functional business logic application, such as a scorecard application, hosting analytical functionality in a client deployed service platform. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer pogrom product or computer readable media. The computer program product may be a computer storage media readable by a computer system and encoding a computer pogrom of instructions for executing a computer process. The computer pogrom product may also be a propagated signal on a carrier readable by a computing system and encoding a computer program of instructions for executing a computer process.

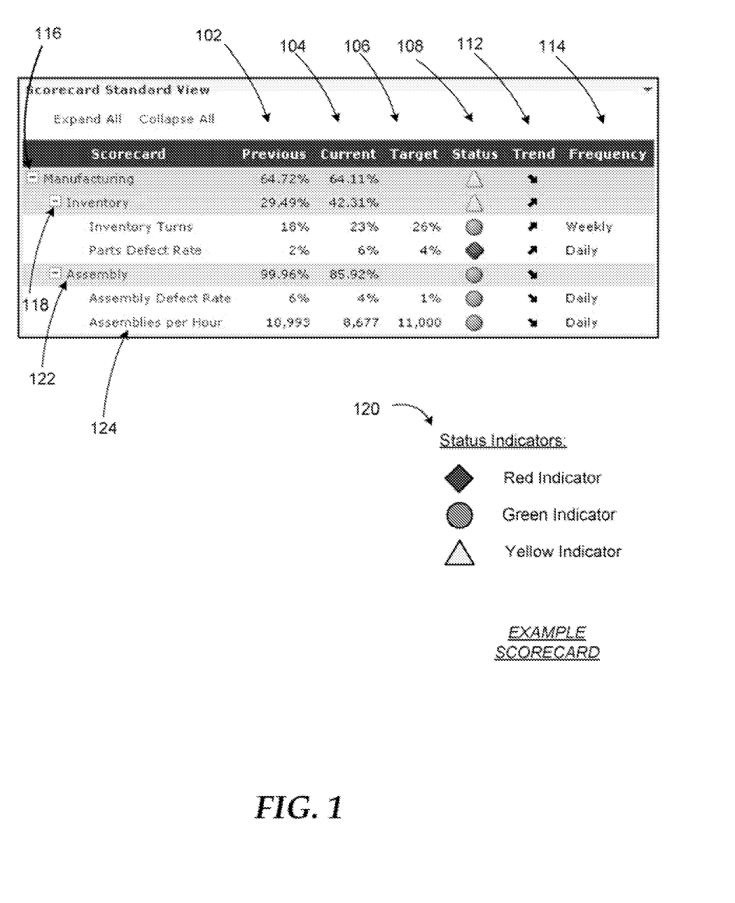

FIG. 1 illustrates a screenshot of an example scorecard with status indicators 120. As explained before, Key Performance Indicators (KPIs) are specific indicators of organization performance that measure a current state in relation to meeting the targeted objectives. Decision makers may utilize these indicators to manage the organization more effectively.

When creating a KPI, the KPI definition may be used across several scorecards. This is useful when different scorecard managers might have a shared KPI in common. This may ensure a standard definition is used for the KPI. Despite the shared definition, each individual scorecard may utilize a different data source and data mappings for the actual KPI.

Each KPI may include a number of attributes. Some of these attributes include frequency of data, unit of measure, trend type, weight, and other attributes.

The frequency of data identifies how often the data is updated in the source database (cube). The frequency of data may include: Daily, Weekly, Monthly, quarterly, and Annually.

The unit of measure provides an interpretation for the KPI. Some of the units of measure are: Integer, Decimal, Percent, Days, and Currency. These examples are not exhaustive, and other elements may be added without departing from the scope of the invention.

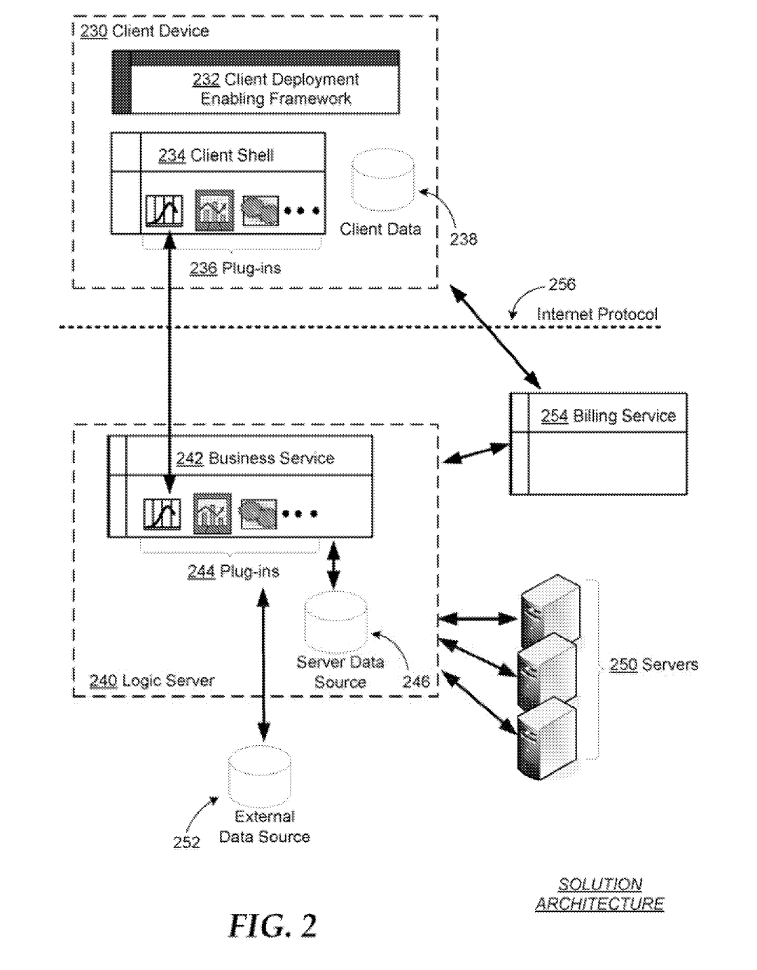

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The arrows displayed in the scorecard of FIG. 2 indicate how the numbers are moving this period compared to last. If in this period the number is greater than last period, the trend is up regardless of the trend type. Possible trend types may include: Increasing Is Better, Decreasing is Better, and On-Target is Better.

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent metric.

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, dates, and hyperlinks.

One of the benefits f defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

First column of the scorecard shows example top level metric 116 “Manufacturing” with its reporting KPIs 118 and 122 “Inventory” and “Assembly”. Second column 102 in the scorecard shows results for each measure from a previous measurement period. Third column 104 shows results for the same measures for the current measurement period. In one embodiment, the measurement period may include a month, a quarter, a tax year, a calendar year, and the like.

Fourth column 106 includes target values for specified KPIs on the scorecard. Target values may be retrieved from a database, entered by a user, and the like. Column 108 of the scorecard shows status indicators 120.

Status indicators 120 convey the state of the KPI. An indicator may have a predetermined number of levels. A traffic light is one of the most commonly used indicators. It represents a KPI with three-levels of results—Good, Neutral, and Bad. Traffic light indicators may be colored red, yellow, or green. In addition, each colored indicator may have its own unique shape. A KPI may have one stoplight indicator visible at any given time. Other types of indicators may also be employed to provide status feedback. For example, indicators with more than three levels may appear as a bar divided into sections, or bands. Column 112 includes trend type arrows as explained above under KPI attributes. Column 114 shows another KPI attribute, frequency.

FIG. 2 illustrates an example solution architecture for business objects using a client deployment platform. Client deployed applications provide an approach for rich client applications to be provided on a user's desktop by placing the application files on a web or file server accessible to the user and by providing the user with a link. When the user activates the link on a web page, in an e-mail, and the like (context-based launching) the application files are downloaded to the user's machine and executed.

When a new version of the application is deployed to the server, it may be automatically detected by connected clients, and the update can be downloaded and applied in a variety of ways based on optional deployment settings. According to some embodiments, applications may be deployed offline as well, making the application behave as if it had been installed on the local machine. To accomplish a trustworthy deployment model for users to be able to download and execute applications from centrally managed servers without requiring administrator privileges on the client machine, the application may be deployed in a safe manner that prevents them from interfering with or corrupting any other applications or data on the client. Applications deployed according to embodiments may be run in a secure execution context where permissions may be limited based on where the application is coming from or the trust assigned to the originator of that application.

A client deployed business application according to embodiments may also include an infrastructure for billing both the platform services and services offered by third parties who create additional offerings that are then seamlessly downloaded to communities of distributed users. Such a system provides users the ability to work with a hosted application with a substantially same responsiveness and reliability as a natively installed application, to continue working while disconnected from the core service, and to have services upgraded without significantly disrupting their work. The system may also provide third parties with the ability to granularly provide services to users over networks.

The architecture in FIG. 2 includes client device 230 with client shell 234, client data source 238, and client deployment enabling framework 232, communicating with business service 242 on logic server 240 through internet protocol (IP) 256.

As described above, scorecards are an easy method of evaluating organizational performance. The performance measures may vary from financial data such as sales growth to service information such as customer complaints. In a non-business environment, student performances and teacher assessments may be another example of performance measures that can employ scorecards for evaluating organizational performance. A scorecard engine module is typically arranged to evaluate performance metrics. The scorecard engine may be executed at the core server running business service 242, on client device 230 following a download by the client, or distributed over a network.

Data for evaluating various measures may be provided by external data sources 252 or server data source 246. The data sources may include a number of data stores such as spreadsheets, SQL databases, document libraries, or multi-dimensional databases such OLAP, that provide raw data for generation of scorecards. Multi-dimensional databases for storing data may be used in determining Key Performance Indicators (KPIs) as well as generated scorecards themselves. As discussed above, the multi-dimensional nature of data sources enables storage, use, and presentation of data over multiple dimensions such as compound performance indicators for different geographic areas, organizational groups, or even for different time intervals. The data sources may have a bi-directional interaction with business service 242 providing and receiving raw data as well as generated scorecards.

Client device 230 may also include a client data store 238 for providing client data to the performance metric computation process and storing results such as reports locally. Furthermore, billing service 254 may interact with both client device 230 and business service 242 via IP 256 and keep track of billable activities. Billing data may be stored by the billing service 254, at the client data store 238, or by business service 242.

In an operation, a user may activate downloading of one or more plug-in modules to client shell 234 by launching context based links at business service 242. Business service 242 may make available a number of plug-in modules 244 at the logic server 240. Some or all of the modules may be downloaded to client device 230 automatically or manually based on user selection, user profile, permission levels, and the like. The user may also receive additional plug-in modules from third parties to the client shell 234. Once the plug-in module 236 are downloaded, they may be activated automatically or as needed. By executing the plug-in modules in a cache memory of client device 230, the functionality of business service 242 may be provided to the user without having him/her go through a full installation and activation process. Indeed, a user may download and execute the plug-ins on any machine with basic security measures (e.g. a public terminal) upon logging in. When the user logs out, the modules automatically disappear from the terminal providing the user with the flexibility of accessing the scorecard functionality from anywhere in a secure manner.

Logic server 240 may be a virtual server associated with multiple physical servers (250) or a physical server associated with multiple virtual servers. This enables data protection by providing redundancy (in case one or more of the servers is down) as well as efficient use of system resources through load balancing.

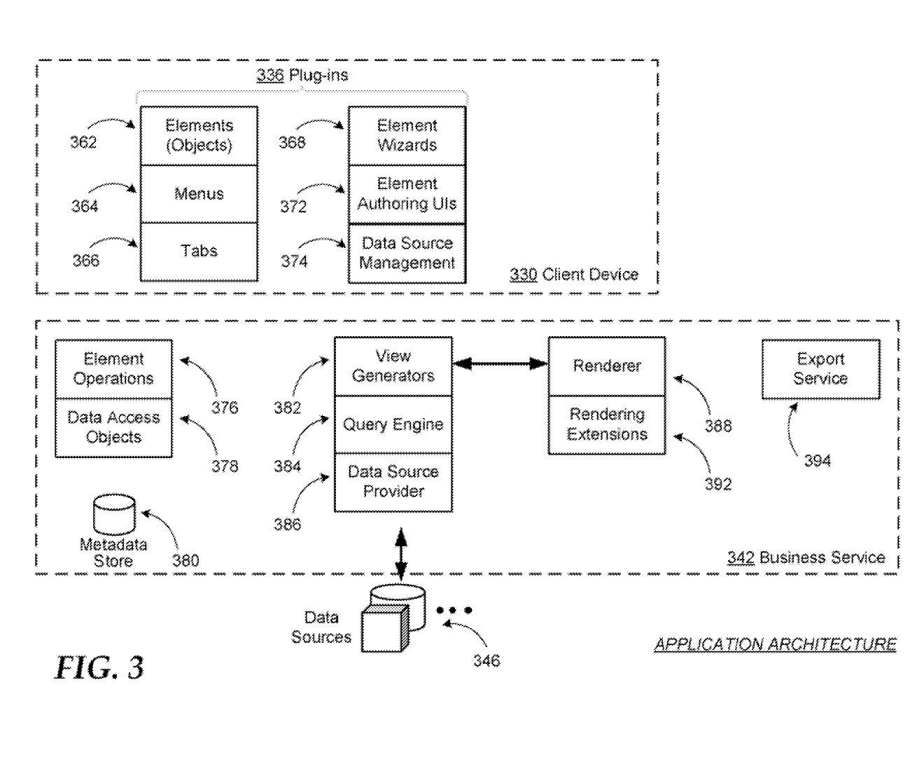

Referring to FIG. 3, an example application architecture for business objects using a client deployment platform is illustrated. Example modules within the client and service applications are shown in detail.

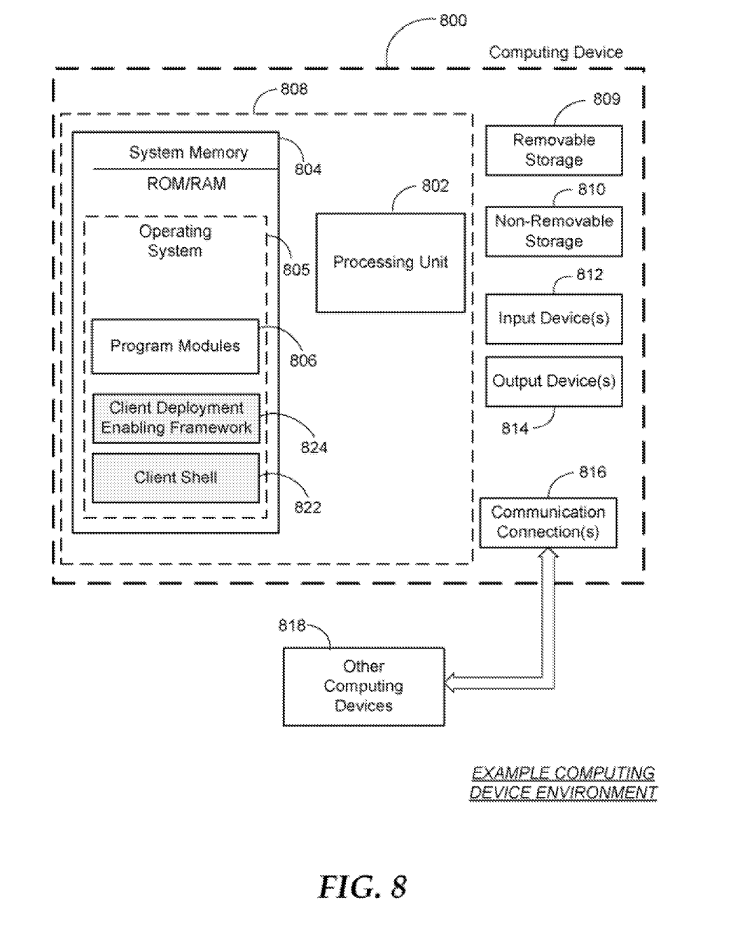

Client device 330 includes, in addition to any standard programs as described in FIG. 8, plug-in modules 336 downloaded from business service 342. The main plug-ins for a client deployed business application include elements 362 (or first class objects) for defining and performing performance metric based operations; menus 364 for providing the user with actions such as publishing, viewing, and the like, tabs 366 for providing the user with a categorized listing of available elements; element wizards 368 for creating new metrics or scorecards; and element authoring user interfaces 372 for editing various aspects of the scorecard operations such as data source editing, report view editing, and the like. A data source management plug-in 374 may also be included for managing client data sources and/or performing security, resource usage, and maintenance operations associated with data exchanged between business service 342 and client device 330.

When a request to render a scorecard page is received by the server, renderer 388 renders scorecard views in coordination with rendering extensions 392, with data coming back from both dimensional and non-dimensional data sources 346, and report views, subordinate reports for the scorecard that may or may not include data.

When a scorecard view is rendered renderer 388 also receives view data from view generator 382 that uses a query engine 384 to efficiently retrieve data in a multi-dimensional format from one or more data source providers 386 that connect to data sources 346.

Rendering extensions 392 may be made available to third parties implementing their own subordinate reports associated with a scorecard. At view time, manipulations to the scorecard such as page filter, KPI, row, column, and/or cell selection may be passed back to the server under a client deployment enabling framework for the report view to refresh with the appropriate third party defined behavior without page refresh.

View generators 382 also access definitions for scorecards, report views, and other objects stored in the metadata store 380 via data access objects 378 that implement element operations 376, such as create, read, update, delete, versioning, reverting, and object comparison with appropriate system security. Metadata store 380 may provide core metadata in a relational store that can be used to generate reports. Detailed metadata may be accessed via a query from the same database.

The basic data source types available in a default system may be supplemented with custom data source providers by third parties (installed on the server) with their own data source editors available in the client shell. Data source management including security and other element operations may be made available to all new plug-ins. Furthermore, third parties may create plug-ins for deploying to their solutions, which can render scorecards, report views, and the like, via the business service or an application DLL.

Renderer 388 may output individual reports that include charts, spreadsheets, commentary compilations, and the like. According to some embodiments, export service 394 may be employed to combine the individual outputs into a combined presentation such as a briefing book and provide in a predefined format. For example, a number of EXCEL® spreadsheets, a WORD® document, and a number of charts may be combined into a POWERPOINT® presentation and exported to a designated target.

According to other embodiments, a view data transform may be applied as either a pre-processing operation done on a scorecard request prior to being sent to the view renderer (example: programmatically adding a per-user page filter to scorecard request) or a post-processing operation that can be applied on the data set returning from the view renderer (example: creating custom filters on results set of data coming back). The view data transform may be applied for rendering functionality that is not handled by the default modules of the hosted application for scorecards.

Business service 342 may also include a scorecard builder for configuring various parameters of a scorecard such as scorecard elements, default values for actuals, targets, and the like. Moreover, a strategy map builder may be employed for a later stage in scorecard generation process. Scores for KPIs and other metrics may be presented to a user in form of a strategy map. Strategy map builder may include a user interface for selecting graphical formats, indicator elements, and other graphical parameters of the presentation. As such, the strategy map builder may interact with view generators 382.

The architectures shown in FIG. 2 and FIG. 3 are illustration purposes and do not constitute a limit on embodiments. A business service and associated client shells may be implemented with fewer or additional components and interactions between the components without departing from a scope and spirit of the disclosure.

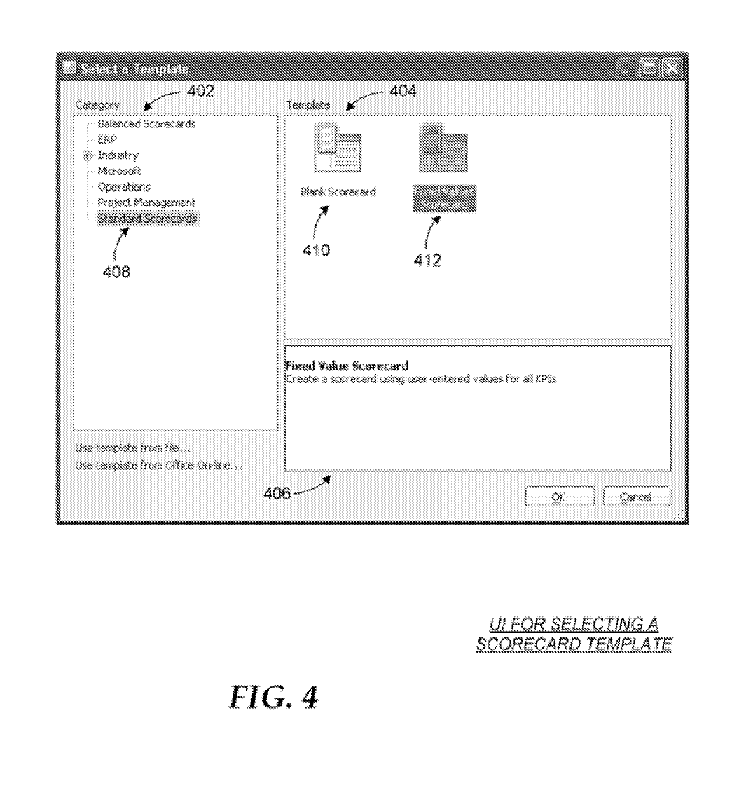

FIG. 4 illustrates an example user interface for selecting a scorecard template in a client deployed application. The hosted plug-ins may be installed on a local machine by modifying standard configuration files and registering appropriate DLLs. A wizard experience may be provided to users for generating a scorecard from a template.

A template may be selected from a file where the user interface brings up a file dialog in which a user can open an existing scorecard template file. According to another approach, an online service may be activated for the user to download a template. According to some embodiments, a preview of templates may be provided with a title of the template. Some templates may have an icon superimposed on their preview with hover over text indicating an attribute of the template.

The example user interface includes three panels. Panel 402 displays a listing of available scorecard categories. The list may be provided in a collapsible tree list format of any other format. In the example user interface, the selected category “Standard Scorecards” 408 is highlighted. Panel 404 displays available scorecard templates. The available templates may be presented as icons, in a tree listing format, or any other format. In the example, two templates are displayed as icons: blank scorecard template 410 and fixed values attribute 412. Panel 406 of the user interface is a rich text area with a description of the selected template to provide users information.

Performance metrics such as KPIs may also be created using a process similar to scorecard creation. Conceptual templates may be configured via a predefined format such as an XML schema. If the template is attributed a wizard driven behavior, these may be driven by a DLL placed in an appropriate directory and referenced in the configuration file.

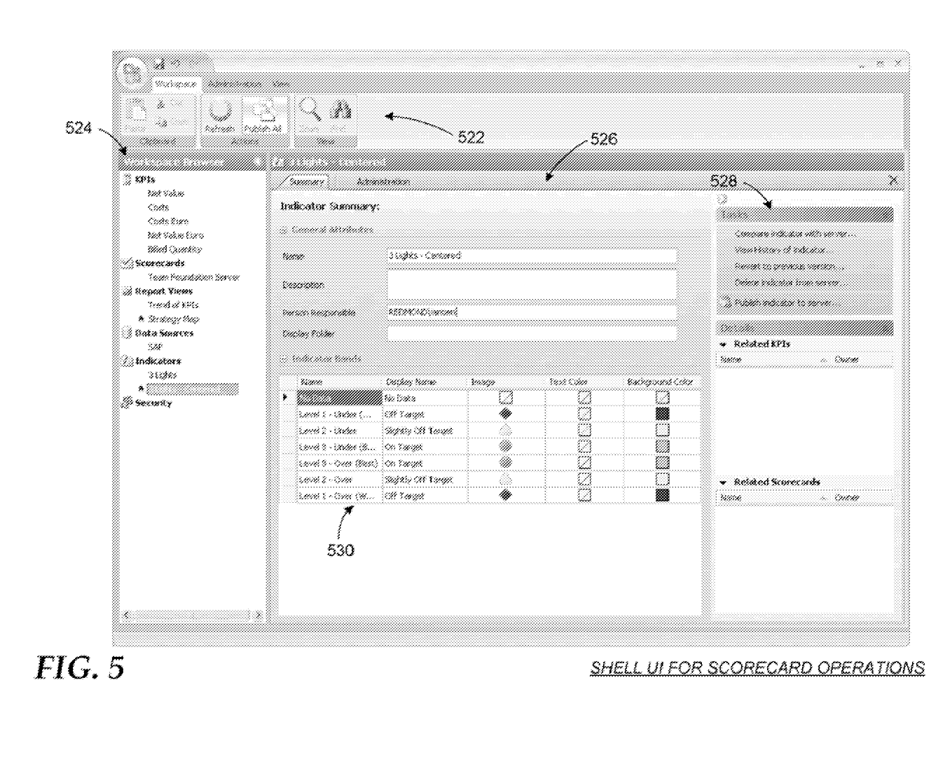

FIG. 5 illustrates and example user interface for scorecard operations in a client deployed application. A client deployed business application for performing scorecard operations according to embodiments may include default plug-in objects such as KPIs, scorecards, report views, data sources and indicator sets. Additional objects may be provided by user definition and/or by third party providers. The user interface may include a “Tab and Pane” interaction model where the selection of an object listed on a side tab brings up a user interface in the center pane to manipulate the object. For example, selecting a scorecard may bring up a view authoring user interface with a preview control for bringing data back from the server.

Default objects may have element operations and data access object capabilities, and may be stored in the metadata store of the core server. Furthermore, support for element authoring, such as save, undo, redo, etc. may be made available for plug-in object user interfaces.

The objects may be accessed in the client shell via a plug-in solution wizard experience for creating new objects. Menu pane 522 may provide access to various menu actions such as copying, pasting, publishing, viewing, and the like. The object pane, as mentioned above, provides a specific user interface for the selected object. In the example, object pane 526 displays names, descriptions, and detailed attributes of indicators available in the system (the selected item in the tab pane 524). A side panel 528 on the object pane provides additional information such as a list of tasks associated with the selected object, related KPIs, and the like.

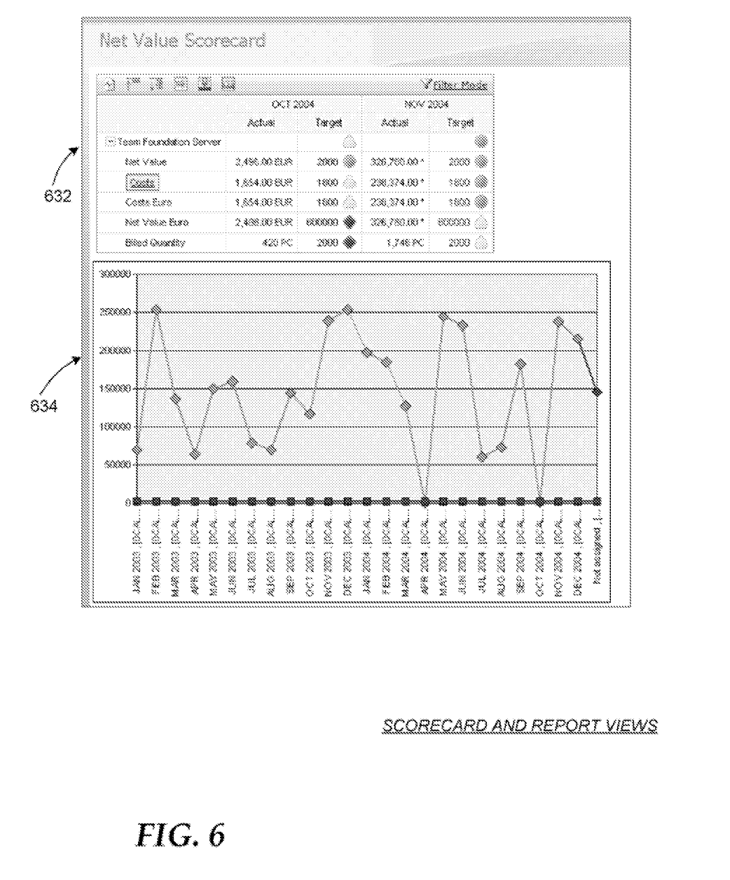

FIG. 6 illustrates example scorecard and report views in a client deployed scorecard application. Upon selection of a desired scorecard template, data sources associated with the scorecard, and configuration parameters for the scorecard and associated report views, the client deployed application may perform operations on the local machine despite not being fully installed on a hard drive of the local machine. This way, the full experience of the scorecard application is provided to the user without burdening them with the complications of full local installation.

As shown in the figure, scorecard 632 is presented in a grid format with the metrics listed as a collapsible list in the first column. The actuals and targets (as well as the status indicators) for each metric are displayed in corresponding rows grouped by time dimensions (e.g. October 2004, November 2004).

Underneath the scorecard is report view 634 showing data for a selected metric (“costs” in the example) in a chart format over a selected period. Depending on user selection, various report views may be generated by the application. The illustrated scorecard and report may also include interactive elements. For example, upon clicking on an element such as a data point, a metric, an axis, and the like, the user may be provided a user interface for modifying the attributes of that particular element, or adding a new element.

It should be noted that while the example user interfaces present particular configurations of scorecard elements, reports, templates, and the like, embodiments are not limited to those illustrated. Other configurations may be implemented without departing from a scope and spirit of the disclosure.

Embodiments are not limited to the example user interfaces, layouts, and operations discussed above. Many other types of operations may be performed and interfaces/layouts used to implement providing a client deployed business logic application using the principles described herein.

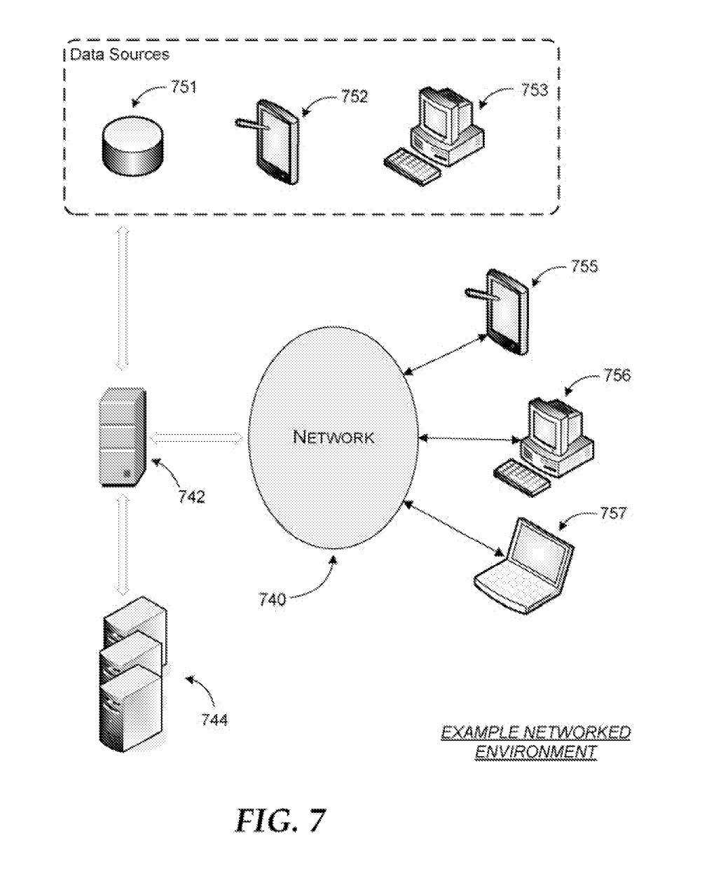

Referring now to the following figures, aspects and exemplary operating environments will be described. FIG. 7, FIG. 8, and the associated discussion are intended to provide a brief, general description of a suitable computing environment in which embodiments may be implemented.

FIG. 7 illustrates implementation of client deployed business performance applications in a networked system. The system may comprise any topology of servers, clients. Internet service providers, and communication media. Also, the system may have a static or dynamic topology. The term “client” may refer to a client application or a client device employed by a user to perform operations associated with providing business objects within a client deployed service architecture. While a networked business logic system may involve many more components, relevant ones are discussed in conjunction with this figure.

In a typical operation according to embodiments, a hosted business logic service may be provided centrally from server 742 or in a distributed manner to client devices 755-757. Server 742 may include implementation of a number of information systems such as performance measures, business scorecards, and exception reporting. A number of organization-specific applications including, but not limited to, financial reporting/analysis, booking, marketing analysis, customer service, and manufacturing planning applications may also be configured, deployed, and shard in the networked system.

Data sources 751-753 are examples of a number of data sources that may provide input to server 742. Additional data sources may include SQL servers, databases, non multi-dimensional data sources such as text files or EXCEL® sheets, multi-dimensional data source such as data cubes, and the like.

Users may interact with server 742 running the business logic service from client devices 755-757 over network 740 and download plug-in modules, data, updates, and the like. Once the hosted applications are downloaded and executed on the client devices, users may access data from server 742 and perform analysis on their own machines.

Client devices 755-757 or servers 742 and 744 may be in communications with additional client devices or additional servers over network 740. Network 740 may include a secure network such as an enterprise network, an unsecure network such as a wireless open network, or the Internet. Network 740 provides communication between the nodes described herein. By way of example, and not limitation, network 740 may include wired media such as a wired network or direct-wired connection, and wireless media such as acoustic, RF, infrared and other wireless media.

Many other configurations of computing devices, applications, data sources, data distribution and analysis systems may be employed to implement a client deployed business application. Furthermore, the networked environments discussed in FIG. 7 are for illustration purposes only. Embodiments are not limited to the example applications, modules, or processes. A networked environment for may be provided in many other ways using the principles described herein.

With reference to FIG. 8, a block diagram of an example computing operating environment is illustrated, such as computing device 800. In a basic configuration, the computing device 800 typically includes at least one processing unit 802 and system memory 804. Computing device 800 may include a plurality of processing units that cooperate in executing programs. Depending on the exact configuration and type of computing device, the system memory 804 may be volatile (such as RAM), non-volatile (such as ROM, flash memory, etc.) or some combination of the two. System memory 804 typically includes an operating system 805 suitable for controlling the operation of a networked personal computer, such as the WINDOWS® operating system from MICROSOFT CORPORATION or Redmond, Wash. The system memory 804 may also include one or more software applications such as program modules 806, client shell application 822, and client deployment enabling framework 824.

Client shell application 822 may be any application that facilitates deployment of hosted applications on computing device 800. Client deployment enabling framework 824 may be an integral part of operating system 805 or a separate module and provide necessary infrastructure for applications and plug-ins to be deployed on computing device 800. Client shell application 822 may communicate with other applications running on computing device 800 or on other devices. This basic configuration is illustrated in FIG. 8 by those components within dashed line 808.

The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by removable storage 809 and non-removable storage 810. computer storage media may include volatile and nonvolatile, removable and non-removable media implemented in any method or technology for storage of information, such as computer readable instructions, data structures, program modules, or other data. System memory 8490, removable storage 809 and non-removable storage 810 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of device 800. Computing device 800 may also have input device(s) 812 such as keyboard, mouse, pen, voice input device, touch input device, etc. Output device(s) 814 such as a display, speakers, printer, etc. may also be included. These devices are well known in the art and need not be discussed at length here.

The computing device 800 may also contain communication connections 816 that allow the device to communicate with other computing devices 818, such as over a network in a distributed computing environment, for example, an intranet or the Internet. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

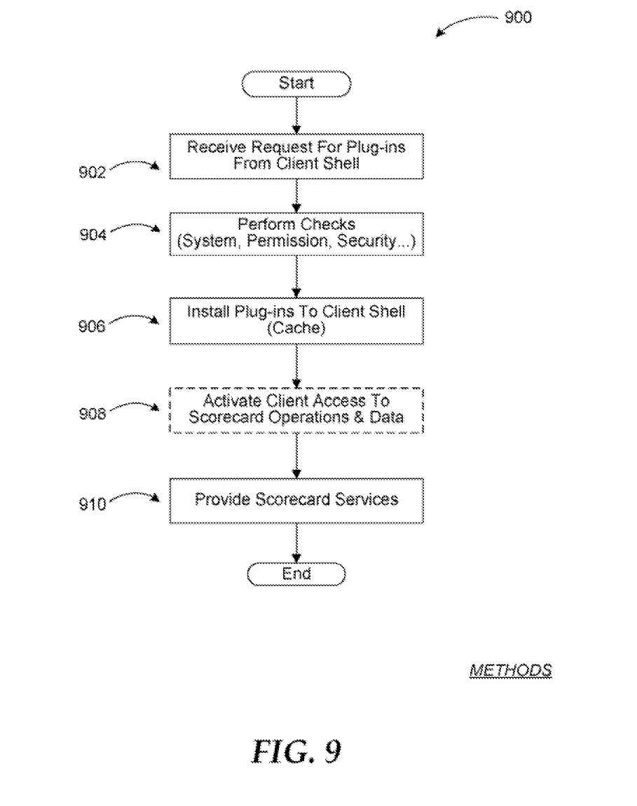

FIG. 9 illustrates a logic flow diagram for a process of installing and operating a client deployed scorecard application. Process 900 may be implemented in a hosted application platform that performs, among other things, performance indicator related tasks.

Process 900 begins with operation 902, where request is received from a client shell for plug-in modules. The request may be made manually by a user for selected plug-ins or automatically (e.g. the user logging in at the client device). Processing advances from operation 1302 to operation 1304.

At operation 1304, predefined checks such as a security check, permission level check, system resource availability check, and so on, are performed. Downloading and execution of the plug-in modules may be enabled based on these checks. For example, if a security level of the client connection is below a preset threshold, access to portions of data may be limited while certain functionalities may be allowed. Processing proceeds from operation 1304 to operation 1306.

At operation 1306, the plug-ins are downloaded and executed at the client shell subject to the checks performed at the preceding operation. The plug-ins may be executed automatically or based on a sequence of operations. Upon downloading the functionality offered by the plug-in modules is available to the user from a cache memory of the client device. Thus, when the user logs out or turns off the client device, all plug-in modules disappear from the client device providing a secure mechanism to use the business service remotely. According to some embodiments, off-line operation may be enabled allowing the user to continue working even if the connection to the core server is severed. Such functionality may be coupled with a synchronization feature enabling user data to be synchronized with the server data upon reconnect. Processing moves from operation 1306 to optional operation 1308.

At optional operation 1308, client access to scorecard operations and data may be activated. The activation may be a secondary security mechanism checking the user's permission levels and client environment's security features against defined requirements at the business service side. Processing advances from option operation 1308 to operation 1310.

At operation 1310, scorecard services are provided to the user through the plug-in modules on the local machine. After optional operation 910, processing moves to a calling process for further actions.

The operations included in process 900 are for illustration purposes. Providing business objects within a client deployed service architecture may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for providing objects within a hosted business service architecture, the method comprising:
providing a context-based link for downloading a module associated with the hosted business service;
receiving a request form a client shell for the module;
authorizing the downloading of the module; and
enabling the client shell to download the module such that the module is executed in a cache memory of a client device associated with the client shell for performing scorecard operations, wherein the client shell is billed for use of the business service by tracking activities associated with the downloaded module.

2. The method of claim 1, wherein modules are maintained on the client shell as generic objects associated with at least one from a set of: scorecards, performance metrics, status indicators, scorecard members, scorecard dimensions, scorecard annotations, scorecard reports, and scorecard data management.

3. The method of claim 1, further comprising:
providing a user interface on the client shell that includes a menu pane for actions associated with scorecard operations, a tab pane for providing a categorized list of available scorecards and scorecard elements, and an authoring pane for editing scorecards and reports.

4. The method of claim 1, further comprising:
providing a plurality of modules to be downloaded, wherein the modules are downloaded and executed based on one from a set of: a user selection, a user profile, a client device security level, and a predefined grouping of modules.

5. The method of claim 1, wherein authorizing the downloading of the module includes performing a check for at least one from a set of: a user permission level, a client device permission level, a communication security level, and a system resource availability.

6. The method of claim 1, further comprising:
if the module fails to be executed on the client shell during a first try, disabling the downloading of the module to the client shell during a second try.

7. The method of claim 1, further comprising:
automatically updating at least one of the module and data associated with the module on the client shell in response to a change to one of the module and the data associated with the module at a server hosting the business service.

8. The method of claim 1, wherein the client shell is billed for the use of the business service by at least one of the business service and a third party provider.

9. The method of claim 1, further comprising enabling offline operation of the client shell by providing synchronization between client data and server data upon reconnect.

10. The method of claim 1, further comprising enabling embedded applications on the client shell by providing activation links to one or more applications associated with the downloaded module.

11. The method of claim 1, further comprising:
registering the downloaded module with a configuration file residing on one of the client device and a server providing the business service.

12. A system for providing objects within a hosted business service architecture, comprising:
a memory;
a processor coupled to the memory, wherein the processor is configured to execute instructions to perform actions including:
provide a context-based link for downloading a module associated with the hosted business service;
receive a request from a client shell for the module;
authorize the downloading of the module;
enable the client shell to download the module such that the module is executed in a cache memory of a client device associated with the client shell for performing scorecard operations; and
enable a user to be billed for use of the business service by tracking activities associated with the downloaded module.

13. The system of claim 12, further comprising:
a data store configured to store at least one from a set of: a plurality of modules associated with the hosted business service, data associated with the scorecard operations, user profile information, and data associated with scorecard operations performed by the client shell.

14. The system of claim 13, wherein the processor is further configured to automatically update at least one item in the data store in response to a scorecard operation performed by the client shell.

15. The system of claim 12, wherein the processor is further configured to provide information associated with the tracked client shell activities to a third party provider for enabling the third party provider to bill the user for the use of the business service.

16. The system of claim 12, wherein the processor is further configured to automatically update at least one of the module and data associated with the module on the client shell in response to a change to the downloaded module.

17. The system of claim 12, wherein the processor is further configured to provide access to at least one application associated with the hosted business service through the downloaded module.

18. A computer-readable storage medium with instructions stored thereon for providing objects within a hosted business service architecture, the instructions comprising:
enabling a user to download a module associated with scorecard operations provided by the hosted business service through a context-based link;
in response to receiving a request for the module from a client shell employed by the user, providing the module for execution in a cache memory of a client device associated with the client shell;
tracking activities associated with the downloaded module for billing the user for use of the business service; and
updating at least one of the downloaded module and a data store associated with the hosted business service based on the tracked activities.
providing a user interface for selecting among available scorecards;

19. The computer-readable storage medium of claim 18, wherein the client shell is enabled to perform actions including:
configuring parameters associated with at least one element of a scorecard;
performing the statistical analysis on scorecard data based on the configured parameters; and
rendering a report based on the configured parameters and a result of the statistical analysis.

20. The computer-readable storage medium of claim 19, wherein the instructions further comprise:
confirming a security status of at least one from a set of: the user, the client shell, and a network connection between the client shell and the hosted business service;
registering the downloaded module with a configuration file residing on one of the client device and a server providing the hosted business service; and
providing the user billing information based on the tracked activities.
